(19) United States
(12) Patent Application Publication
(10) Pub. No.: US 2011/0068758 A1
(43) Pub. Date: Mar. 24, 2011

(54) REGULATED CIRCUITS AND OPERATIONAL AMPLIFIER CIRCUITS

(76) Inventor: Po-Han Chiu, Hsin-Chu (TW)

(21) Appl. No.: 12/860,938

(22) Filed: Aug. 23, 2010

(30) Foreign Application Priority Data
Sep. 18, 2009 (TW) 098131619

(51) Int. Cl. G05F 1/00

(52) U.S. Cl. 323/280

(57) ABSTRACT

Circuits providing a regulated voltage. An output stage has a power switch with a control node, a power input node and a power output node. The power input node is coupled to a source voltage and the power output node provides the regulated voltage. An amplifier stage compares a feedback voltage with a reference voltage, having first and second output nodes. The feedback voltage is about in proportion to the regulated voltage. A buffer stage has an input node connected to the first output node. The output node of the buffer stage and the second output node of the amplifier stage together drive the control node of the output stage.

### BACKGROUND OF THE INVENTION

1. Field of the Invention

The present invention is related to a circuit and a control method thereof, and more particularly, to an operational amplifier and a regulated circuit and a control method thereof.

2. Description of the Prior Art

Most circuits require a stable and specific voltage for proper operation. While grid power lines or batteries are convenient for use, they may not be suitable for each and every circuit because the voltages they provide range widely. Therefore, different regulator circuits are developed to convert output voltage of an energy source to a stable voltage for different circuit applications.

A low dropout (LDO) voltage regulator is a voltage converter used to convert a DC power source and deliver a stable output voltage. An LDO voltage regulator, for example, comprises a power switch, which is typically a field effect transistor, coupled between an input power source and an output power source. Channel resistance of the power switch is controlled via a feedback mechanism so as to regulate the output voltage.

FIG. 1 is a diagram of a conventional LDO voltage regulator. P-type metal oxide semiconductor (PMOS) transistor MP0 acts as a power switch. Resistors R1 and R2 generate feedback voltage V_{fb}. Transconductance amplifier GM compares feedback voltage V_{fb} with a predetermined reference voltage V_{ref}. Transconductance amplifier GM usually has a large output resistance, so when driving the gate end of PMOS transistor MP0, the signal transient response speed of the LDO voltage regulator is relatively slow due to the large parasitic capacitance at the gate end of PMOS transistor MP0. Therefore, buffer BUFFER is disposed between transconductance amplifier GM and PMOS transistor MP0 to provide a higher input resistance and a lower output resistance. By this way, the signal transient response speed of the LDO voltage regulator can be increased.

Numerous buffer structures are disclosed in the prior art. According to U.S. Pat. Nos. 6,501,305 and 5,861,736, the buffer may be an emitter follower, a source follower or a push-pull amplifier, as shown in FIG. 2A, 2B and 2C, respectively.

### SUMMARY OF THE INVENTION

The present invention discloses a regulated circuit for providing a regulated voltage. The regulated circuit comprises an output stage, an amplifier stage and a buffer. The output stage comprises a power switch with a control node, a power input node and a power output node. The power input node is coupled to a source voltage. The power output node is for providing the regulated voltage. The amplifier stage comprises a first output node and a second output node, for comparing a feedback voltage approximately proportional to the regulated voltage with a reference voltage. The buffer comprises an output node and an input node coupled to the first output node. The output node of the buffer and the second output node of the amplifier stage collectively drive the control node of the output stage. Output resistance of the output node of the buffer is lower than that of the second output node of the amplifier stage.

The present invention further discloses an operational amplifier circuit. The operational amplifier comprises an amplifier stage and a push-pull buffer. The amplifier stage comprises a pair of first output nodes and a second output node, for comparing a first input signal and a second input signal. The push-pull buffer comprises a pair of input nodes and an output node, the pair of input nodes coupled to the pair of first output nodes accordingly. The output node of the buffer and the second output node of the amplifier stage collectively drive an output load. Output resistance of the output node of the buffer is lower than that of the second output node of the amplifier stage.

The present invention further discloses a regulated circuit for providing a regulated voltage. The regulated circuit comprises an output stage, an amplifier stage and a buffer. The output stage comprises a power switch with a control node, a power input node and a power output node. The power input node is coupled to a source voltage. The power output node is for providing the regulated voltage. The amplifier stage comprises a pair of first output nodes and a second output node, for comparing a feedback voltage approximately proportional to the regulated voltage with a reference voltage. The buffer comprises a class AB push-pull amplifier with a pair of input nodes and an output node, the pair of input nodes is coupled to the pair of first output nodes.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a conventional LDO voltage regulator.

FIG. 2A-2C are diagrams of numerous buffer structures.

FIG. 3 is a diagram of an LDO voltage regulator according to an embodiment of the present invention.

FIG. 4 is a diagram of the LDO voltage regulator in FIG. 3 according to another embodiment of the present invention.

### DETAILED DESCRIPTION

Further objects of the present invention and more practical merits obtained by the present invention will become more apparent from the description of the embodiments which will be given below with reference to the accompanying drawings. For explanation purposes, components with equivalent or similar functionalities are represented by the same symbols. Hence components of different embodiments with the same symbol are not necessarily identical. Here, it is to be noted that the present invention is not limited thereto.

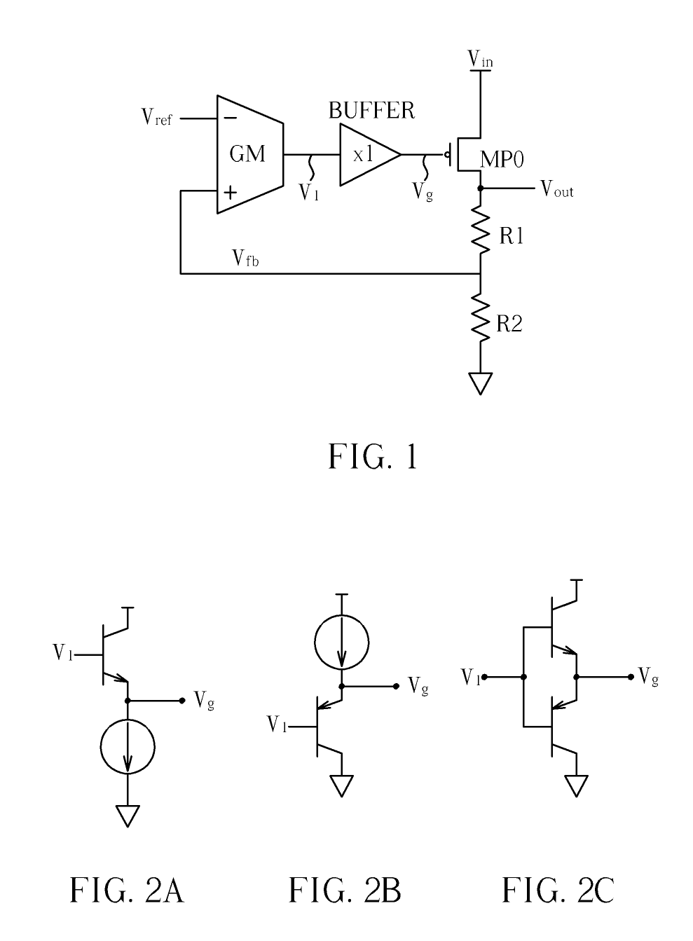

When the LDO voltage regulator of FIG. 1 is paired with any of the buffers shown in FIG. 2A-2C, a problem rises: the gate voltage at the gate end of PMOS transistor MP0 does not swing rail-to-rail. Taking the buffer in FIG. 2C as an example, even if voltage V₁ is as high as source voltage Vᵢₙ of the input power source, gate voltage V_{g} can only be pulled, at best, to the voltage level equivalent to source voltage Vᵢₙ minus activating voltage V_{be-ON} of an NPN transistor. In other words, the gate voltage of PMOS transistor MP0 cannot fully swing between voltage levels of the source voltage Vᵢₙ and ground, consequently lowering dynamic range of the LDO voltage regulator.

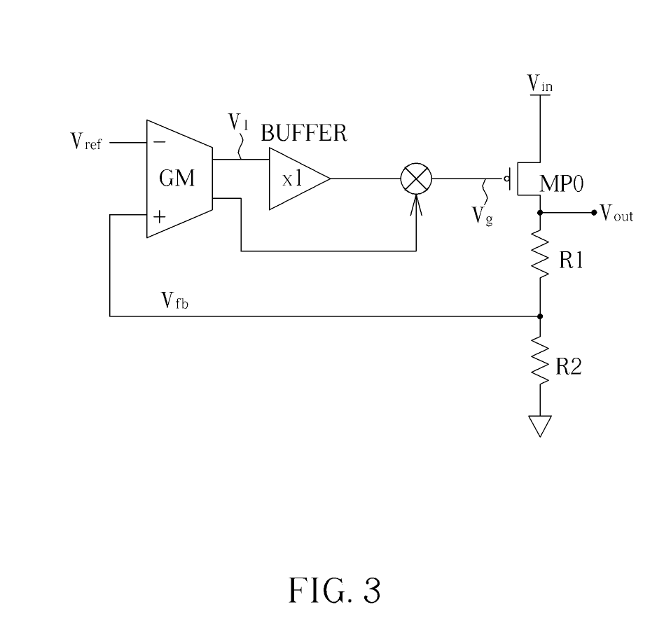

FIG. 3 is a diagram of an LDO voltage regulator according to an embodiment of the present invention. As shown in FIG. 3, transconductance amplifier GM, which is utilized as an amplifier stage, compares feedback voltage V_{fb} and reference voltage V_{ref} at two input nodes. Transconductance amplifier GM comprises two output nodes. Buffer BUFFER, as a buffer stage, is coupled between the first output node of transconductance amplifier GM and a gate end of PMOS transistor MP0. Buffer BUFFER can be realized with an emitter follower or a source follower as shown in FIG. 2A-2C. Buffer BUFFER can also be realized with a class A, class B or class AB amplifier. Overall, transconductance amplifier GM as the amplifier stage and buffer BUFFER as the buffer stage together form an operational amplifier circuit. Voltage gain of buffer BUFFER can approximately be 1. In PMOS transistor MP0 as an output stage, the gate end is not only driven by the output node of buffer BUFFER, but also driven by the second output node of transconductance amplifier GM, as illustrated in FIG. 3. The source end of PMOS transistor MP0 is coupled to source voltage Vᵢₙ, and the drain end provides regulated voltage Vₒᵤₜ.

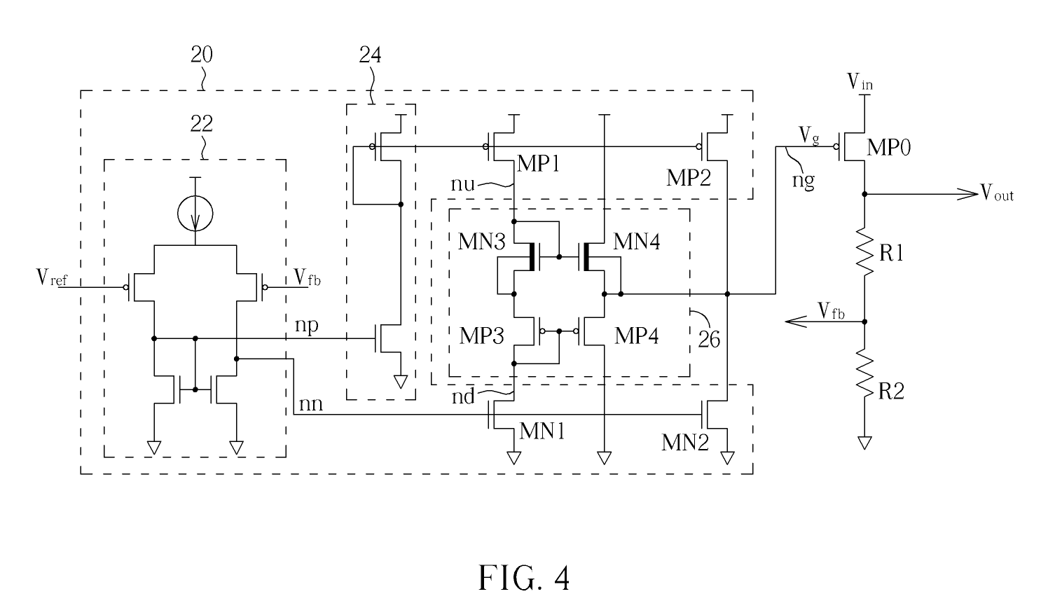

FIG. 4 is a diagram of the LDO voltage regulator in FIG. 3 according to another embodiment of the present invention. Transconductance amplifier 20 comprises differential amplifier 22, which compares feedback voltage V_{fb} and reference voltage V_{ref}. Differential amplifier 22 comprises positive output node np and negative output node nn. Differential amplifier 22 may also be realized by other differential circuits. Circuit 24, together with PMOS transistors MP1 and MP2, may act as a gain circuit with two current output nodes respectively disposed at drain ends of PMOS transistors MP1 and MP2. N-type metal oxide semiconductor (NMOS) transistors MN1 and MN2 may act as another gain circuit with two current output nodes disposed at drain ends of NMOS transistors MN1 and MN2 respectively. The drain ends of PMOS transistor MP1 and NMOS transistor MN1 may operate as one pair of output nodes of transconductance amplifier 20, while the drain ends of PMOS transistor MP2 and NMOS transistor MN2 may operate as another pair of output nodes of transconductance amplifier 20.

Buffer 26 may be a class AB push-pull amplifier and comprises NMOS transistors MN3 and MN4, as well as PMOS transistors MP3 and MP4. Upper input node nu of buffer 26 is coupled to the drain end of PMOS transistor MP1, and lower input node nd is coupled to the drain end of NMOS transistor MN1. In the embodiment illustrated in FIG. 4, NMOS transistors MN3 and MN4 are depletion-mode MOS transistors, while the other NMOS transistors are enhancement-mode MOS transistors. As known by those skilled in the art, an enhancement-mode MOS transistor needs an extra voltage to form a conductive channel between the drain and source ends, while a depletion-mode MOS transistor needs no extra voltage to form the conductive channel. For instance, threshold voltage of an enhancement-mode NMOS transistor has a positive value, and threshold voltage of a depletion-mode MOS transistor is 0 Volts or a negative value. Since NMOS transistors MN3 and MN4 are depletion-mode MOS transistors, when voltage level of upper input node nu reaches voltage level of source voltage Vᵢₙ, gate voltage V_{g} at the gate end of PMOS MP0 may also be pulled up to the voltage level of source voltage Vᵢₙ.

The output node (i.e. the joint node of the source ends of NMOS transistor MN4 and PMOS transistor MP4) of buffer 26 is coupled to one current output node (i.e. the joint node of the drain ends of NMOS transistor MN2 and PMOS transistor MP2) of transconductance amplifier 20 so as to collectively drive the gate end of PMOS transistor MP0 (equivalent to control node ng).

In FIG. 4, output resistance of buffer 26 can be designed to be lower than any output resistance of MN1, MN2, MP1, and MP2. Therefore, buffer 26 may rapidly charge/discharge control node ng, providing a higher signal transient response speed.

When voltage level of lower input node ng of buffer 26 approaches 0V (ground voltage level), buffer 26 is unable to pull gate voltage V_{g} down to 0V since PMOS transistor MP4 is enhancement-mode. However, gate voltage V_{g} may be pulled down to 0V by transconductance amplifier 20 via NMOS transistor MN2. In other words, although buffer 26 is unable to cause gate voltage V_{g} to swing rail-to-rail, since control node ng is also directly driven by one output of transconductance amplifier 20, gate voltage V_{g} can therefore attain rail-to-rail variation.

During normal operation, when feedback voltage V_{fb} diverges from reference voltage V_{ref}, buffer 26 in FIG. 4 promptly drives control node ng to adjust the channel resistance of PMOS transistor MP0, rapidly increasing or decreasing regulated voltage Vₒᵤₜ so as to make feedback voltage V_{fb} approach to reference voltage V_{ref}. In this embodiment, buffer 26 is a class AB push-pull amplifier with two input nodes connecting to nodes nu and nd respectively, so buffer 26 may react to a comparison result of differential amplifier 22 promptly, and quickly alter gate voltage V_{g} at control node ng through push or pull.

Once gate voltage V_{g} exceeds the driving range of buffer 26, transconductance amplifier 20 directly drives control node ng via PMOS transistor MP2 or NMOS transistor MN2, so gate voltage V_{g} can swing rail-to-rail for sustaining the dynamic range.

Those skilled in the art will readily observe that numerous modifications and alterations of the device and method may be made while retaining the teachings of the invention.

What is claimed is:

1. A regulated circuit for providing a regulated voltage, the regulated circuit comprising:
an output stage comprising a power switch with a control node, a power input node coupled to a source voltage, and a power output node for providing the regulated voltage;
an amplifier stage, comprising a first output node and a second output node, for comparing a feedback voltage approximately proportional to the regulated voltage with a reference voltage; and
a buffer comprising an output node and an input node coupled to the first output node;
wherein the output node of the buffer and the second output node of the amplifier stage collectively drive the control node of the output stage and output resistance of the output node of the buffer is lower than that of the second output node of the amplifier stage.

2. The regulated circuit of claim 1, wherein the buffer is a class AB push-pull amplifier.

3. The regulated circuit of claim 1, wherein the buffer comprises a source follower.

4. The regulated circuit of claim 1, wherein the buffer comprises a depletion-mode metal-oxide-semiconductor transistor.

5. The regulated circuit of claim 1, wherein the amplifier stage is a transconductance amplifier comprising a differential amplifier and a gain circuit connected in cascade, the differential amplifier compares the feedback voltage and the reference voltage, and the gain circuit provides output currents at the first output node and the second output node respectively according to output of the differential amplifier.

6. The regulated circuit of claim 5, wherein the amplifier stage comprises only one differential amplifier.

7. The regulated circuit of claim 1, wherein voltage gain of the buffer is approximately 1.

8. The regulated circuit of claim 1, wherein the amplifier stage swings rail-to-rail on the control node.

9. An operational amplifier circuit, comprising:
an amplifier stage, comprising a pair of first output nodes and a second output node, for comparing a first input signal and a second input signal; and
a push-pull buffer comprising a pair of input nodes and an output node, the pair of input nodes coupled to the pair of first output nodes correspondingly;
wherein the output node of the buffer and the second output node of the amplifier stage collectively drive an output load and output resistance of the output node of the buffer is lower than that of the second output node of the amplifier stage.

10. The operational amplifier circuit of claim 9, wherein the push-pull buffer comprises a depletion-mode metal-oxide-semiconductor transistor.

11. The operational amplifier circuit of claim 9, wherein the amplifier stage is a transconductance amplifier comprising a differential amplifier and a gain circuit connected in cascade, the differential amplifier compares the first input signal and the second input signal, and the gain circuit provides an output currents at the first output nodes and the second output node respectively according to output of the differential amplifier.

12. The operational amplifier circuit of claim 11, wherein the amplifier stage comprises only one differential amplifier.

13. The operational amplifier circuit of claim 9, wherein voltage gain of the push-pull buffer is approximately 1.

14. The operational amplifier circuit of claim 9, wherein the amplifier stage swings rail-to-rail on the output load.

15. A regulated circuit for providing a regulated voltage, the regulated circuit comprising:
an output stage comprising a power switch with a control node, a power input node coupled to a source voltage, and a power output node for providing the regulated voltage;
an amplifier stage, comprising a pair of first output nodes and a second output node, for comparing a feedback voltage approximately proportional to the regulated voltage with a reference voltage; and
a buffer, comprising a class AB push-pull amplifier with a pair of input nodes and an output node, the pair of input nodes coupled to the pair of first output nodes.

16. The regulated circuit of claim 15, wherein the buffer comprises a depletion-mode metal-oxide-semiconductor transistor.

17. The regulated circuit of claim 15, wherein the amplifier stage is a transconductance amplifier comprising a differential amplifier and a gain circuit connected in cascade, the differential amplifier compares the feedback voltage and the reference voltage, and the gain circuit provides output currents at the first output nodes and the second output node respectively according to output of the differential amplifier.

18. The regulated circuit of claim 17, wherein the amplifier stage comprises only one differential amplifier.

19. The regulated circuit of claim 15, wherein voltage gain of the buffer is approximately 1.

20. The regulated circuit of claim 15, wherein the amplifier stage swings rail-to-rail on the control node.
